(19) United States
(12) Patent Application Publication
(10) Pub. No.: US 2023/0323864 A1
(43) Pub. Date: Oct. 12, 2023

(54) METHOD FOR REPAIRING A LIGHTNING PROTECTION SYSTEM OF WIND TURBINE ROTOR BLADE

(71) Applicant: LM Wind Power A/S, Kolding (DK)

(72) Inventors: James Robert Tobin, Greenville, SC (US); Steven Haines Olson, Greenville, SC (US); Lars Bo Hansen, Kolding (DK); Matthew Brian Dudon, Greenville, SC (US)

(21) Appl. No.: 18/043,156

(22) PCT Filed: Aug. 27, 2021
(86) PCT No.: PCT/EP2021/073723

§ 371 Date: Feb. 27, 2023

(30) Foreign Application Priority Data
Aug. 31, 2020 (GB) 2013644.6

(51) Int. Cl. F03D 80/50; F03D 80/30

(52) U.S. Cl. CPC F03D 80/50; F03D 80/30; F05B 2230/80

(57) ABSTRACT

A method for repairing or improving a lightning protection system of a rotor blade of a wind turbine having a blade root and a blade tip includes identifying a repair or improvement location in the lightning protection system of the rotor blade. The method includes removing one or more layers of material at the repair or improvement location that form part of a shell of the rotor blade so as to expose existing conductive material in the rotor blade. The method also includes placing a conductive layer of material atop the repair or improvement location such that a root-side edge of the conductive layer overlaps the existing conductive material. Moreover, the method includes electrically connecting the root-side edge of the conductive layer with the existing conductive material and a tip-side edge of the conductive layer of material with the blade tip. The method further includes covering the conductive layer with an outer covering.

### FIELD

The present disclosure relates in general to wind turbine rotor blades, and more particularly to methods for repairing or improving a lighting protection system of a wind turbine rotor blade.

### BACKGROUND

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy from wind using known foil principles and transmit the kinetic energy through rotational energy to turn a shaft coupling the rotor blades to a gearbox, or if a gearbox is not used, directly to the generator. The generator then converts the mechanical energy to electrical energy that may be deployed to a utility grid.

Wind turbine rotor blades generally include a body shell formed of a composite laminate material. In general, the body shell is relatively lightweight and has structural properties (e.g., stiffness, buckling resistance and strength) which are not configured to withstand the bending moments and other loads exerted on the rotor bade during operation. To increase the stiffness, buckling resistance and strength of the rotor blade, the body shell is typically reinforced using spar caps that engage the inner surfaces of the shell. The spar caps may be constructed of various materials, including but not limited to glass fiber laminate composites and/or carbon fiber laminate composites.

During the life of the wind turbine, the rotor blades are particularly prone to lightning strikes. In particular, when carbon fibers are used in the body shell, lightning may attach to these fibers, thereby causing a potential arc through the body shell. Thus, lightning protection systems are essential to protecting wind turbine blades because of their sharp edges and insulation capabilities. Modern lightning protection system typically include one or more lightning receptors disposed on the exterior of the rotor blades and a lightning conductor or cable wire coupled to the lightning receptor(s) and extending through the body shell from a blade tip to a blade root and through other components until grounded down through the tower to a ground location. Accordingly, when lightning strikes the rotor blade, the electrical current flows through the lightning receptor(s) and is conducted through the lightning system to the ground. However, when a lightning strike occurs, unwanted discharges may arise from the spar caps to the body shell, which may cause significant damage to the rotor blade.

Moreover, during the life of a wind turbine, the lightning protection system may become damaged. Due to the importance of maintaining an operational lightning protection system, such damages need to be repaired. However, when repairs are conductive for such lightning protection systems, there are multiple conductive and connectivity issues. For example, typical lightning protection systems do not include lightning protection at the leading and trailing edges of the rotor blade, yet, due to the sharp edges, lightning current attaches to the leading and trailing edges, which can cause splitting of the rotor blades at such locations. This type of damage is particularly difficult damage to repair. Moreover, the contact surface contact area on the root-side of the tip repair, e.g. on the spar cap, is limited and difficult. Without a large surface contact area, the current travels through minimal paths and is not dispersed in strength through parallel paths. Conventional repair methods utilize stainless steel pop rivets, however, the effective of such methods is limited by the contact surface area of the rivets. In addition, the rivets increase the risk of detachment/damage if such rivets receive the full current of the lightning. Still further challenges associated with conventional lightning protection systems include issues associated with the attachment of multiple conductive materials (e.g. such as the attachment between copper and aluminum), which is generally very corrosive and is therefore degrades over time. Therefore, conventional methods of joining two conductive materials also includes the use of stainless steel pop rivets. But, again, effective of such methods is limited by the contact surface area of the rivets and the risk of detachment/damage if the rivets receive the full current of the lightning. Also, stainless steel is not in the same galvanic area as both copper and aluminum, therefore, stainless steel can create galvanic corrosion and possible disconnection of joined conductive materials.

Accordingly, there is a need for an improved method for repairing and/or improving a lighting protection system of a wind turbine rotor blade that addresses the aforementioned issues.

### BRIEF DESCRIPTION

Aspects and advantages of the invention will be set forth in part in the following description, or may be obvious from the description, or may be learned through practice of the invention.

In one aspect, the present disclosure is directed to a method for repairing or improving a lightning protection system of a rotor blade of a wind turbine. The rotor blade has a blade root and a blade tip. The method includes identifying a repair or improvement location in the lightning protection system of the rotor blade. The method also includes removing one or more layers of material at the repair or improvement location that form part of a shell of the rotor blade so as to expose existing conductive material in the rotor blade. Further, the method includes placing a conductive layer of material atop the repair or improvement location such that a root-side edge of the conductive layer of material overlaps the existing conductive material. Moreover, the method includes electrically connecting the root-side edge of the conductive layer of material with the existing conductive material and a tip-side edge of the conductive layer of material with the blade tip. In addition, the method includes covering the conductive layer with an outer covering. By blade tip is preferable meant the outer-most location of the rotor blade and by electrically connecting the root-side edge of the conductive layer of material with the existing conductive material and a tip-side edge of the conductive layer of material with the blade tipis preferable meant that the physical connection is at the blade tip. Accordingly, it is seen that the conductive layer of material preferably extends to the blade tip so as to provide the physical connection.

In an embodiment, the existing conductive material is part of at least one of a spar cap or a shear web of the rotor blade.

In another embodiment, the conductive layer of material may include a first strip of continuous material and a second strip of continuous material extending from the root-side edge of the conductive layer of material to the tip-side edge of the conductive layer of material. In such embodiments, the first and second strips of material have a thickness that is greater than a thickness of remaining portions of the conductive layer of material. In particular embodiments, as an example, the first and second strips of continuous material may include first and second tinned braided cables, respectively. In further embodiments, the first strip of continuous material may be positioned adjacent to a leading edge of the rotor blade and the second strip of continuous material may be positioned adjacent to a trailing edge of the rotor blade.

In additional embodiments, the conductive layer of material may further include a conductive plate secured at the tip-side edge thereof. Thus, in an embodiment, electrically connecting the root-side edge of the conductive layer of material with the existing conductive material and the tip-side edge of the conductive layer of material with the blade tip of the rotor blade may include electrically connecting the root-side edge of the conductive layer of material to the existing conductive material via a conductive adhesive material and electrically connecting the tip-side edge of the conductive layer of material to the blade tip through the conductive plate.

In further embodiments, the method may include securing the tip-side edge of the conductive layer of material to the blade tip through the conductive plate via at least one of one or more fasteners or soldering.

In particular embodiments, the conductive plate may be soldered to the conductive layer of material and the first and second strips of continuous material. In still further embodiments, the conductive layer of material may be a solid sheet, a wire mesh, a webbing, a netting, a woven sheet, or similar.

In an embodiment, covering the conductive layer with the outer covering may include sliding a blade sleeve onto the rotor blade so as to cover the conductive layer of material and securing the blade sleeve to the rotor blade. In such embodiments, the blade sleeve may be a unitary component having a pressure side, a suction side, a first open span-wise end, a second open span-wise end opposite the first open span-wise end, a closed leading edge, and an open trailing edge that may extend past the trailing edge of the rotor blade. In further embodiments, the rotor blade may be configured to extend through the first and second open span-wise ends of the blade sleeve. As such, in an embodiment, sliding the blade sleeve onto the rotor blade so as to cover the conductive layer of material may include separating the pressure and suction sides at the open trailing edge, sliding the open trailing edge of the blade sleeve over the rotor blade, and once the conductive layer of material is covered, securing the pressure and suction sides back together.

In several embodiments, the blade sleeve may be constructed of a thermoplastic material. Further, in another embodiment, the method may include trimming the blade sleeve at and/or along the trailing edge thereof. In such embodiments, trimming the blade sleeve at the trailing edge thereof may include chamfering a root-side edge of the blade sleeve and a tip-side edge of the blade sleeve.

In further embodiments, the method may also include providing one or more finishing components to the blade sleeve once installed on the rotor blade. For example, in an embodiment, the finishing component(s) may include forming at least one drain hole in the blade sleeve, painting or providing a coating onto the blade sleeve, placing a filler material within the blade sleeve, or contouring the blade sleeve to correspond to an exterior surface of the rotor blade.

In another aspect, the present disclosure is directed to a rotor blade assembly. The rotor blade assembly includes a rotor blade extending between a blade root and a blade tip. The rotor blade also has a pressure side, a suction side, a leading edge, and a trailing edge. Further, the rotor blade assembly includes at least one conductive structural component arranged within an inner cavity of the rotor blade and a conductive layer of material adjacent to at least one of the pressure side or the suction side of the rotor blade at the blade tip. The conductive layer of material includes a root-side edge and a tip-side edge. The root-side edge overlaps a portion of the structural component(s) at an interface. The conductive layer of material also includes opposing edges having a thickness that is greater than remaining portions of the conductive layer of material and a conductive plate at the tip-side edge. Moreover, the rotor blade assembly includes a first electrical connection between the root-side edge of the conductive layer of material and the at least one structural component at the interface and a second electrical connection between the tip-side edge of the conductive layer of material, the conductive plate, and a blade tip of the rotor blade. In addition, the first electrical connection includes a conductive adhesive material. It should be understood that the rotor blade assembly may include any of the features discussed above or described in greater detail below.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of wind turbine according to the present disclosure;

FIG. 2 illustrates a perspective view of one embodiment of a rotor blade of a wind turbine according to the present disclosure;

FIG. 3 illustrates a partial, perspective view of one embodiment of a rotor blade having a blade sleeve being secured over a blade tip of the rotor blade according to the present disclosure;

FIG. 4 illustrates a schematic view of one embodiment of a rotor blade of a wind turbine having a lightning protection system according to the present disclosure;

FIG. 5 illustrates a schematic view of another embodiment of a rotor blade of a wind turbine having a lightning protection system according to the present disclosure;

FIG. 6 illustrates a flow diagram of one embodiment of a method for repairing and/or improving a lightning protection system of a rotor blade of a wind turbine according to the present disclosure;

FIG. 7 illustrates a partial, perspective view of one embodiment of a blade tip of a rotor blade according to the present disclosure, particularly illustrating layers of the rotor blade removed during a repair procedure of a lightning protection system thereof;

FIG. 8 illustrates a partial, perspective view of the blade tip of FIG. 7, particularly illustrating a conductive layer placed atop the repair or improvement location;

FIG. 9 illustrates partial, perspective view of one embodiment of a tinned braided cable for a conductive layer of a repair system for a lightning protection system of a rotor blade according to the present disclosure;

FIG. 10 illustrates a partial, perspective view of the blade tip of FIG. 8, particularly illustrating the conductive layer being electrically connected to the blade tip of the rotor blade;

FIG. 11 illustrates a cross-sectional view of one embodiment of the electrical connection between a conductive plate of a conductive layer and the blade tip of the rotor blade;

FIG. 12 illustrates a partial, perspective view of the blade tip of FIG. 10, particularly illustrating an adhesive material placed atop the conductive layer for securing a blade sleeve thereto;

FIG. 13 illustrates a partial, perspective view of the blade tip of FIG. 12, particularly illustrating the blade sleeve secured to the blade tip at the repair or improvement location;

FIG. 14 illustrates a partial, perspective view of the blade tip of the rotor blade according to the present disclosure, particularly illustrating the blade sleeve secured to the blade tip at the repair or improvement location;

FIGS. 15-19 illustrate schematic diagrams of the blade tip of the rotor blade, particularly illustrating steps of installing the blade sleeve of the rotor blade thereto;

FIG. 20 illustrates a partial, perspective view of the blade tip of FIG. 13, particularly illustrating a trimming procedure being performed to the blade sleeve after installation; and

FIG. 21 illustrates a partial, perspective view of the blade tip of FIG. 20, particularly illustrating at least one additional feature formed into the blade sleeve.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to a method for repairing or improving a lightning protection system of rotor blade of a wind turbine. Once layers of the rotor blade have been removed to expose existing conductive material, the method includes placing a conductive layer of material atop the repair or improvement location such that a root-side edge of the conductive layer of material overlaps the existing conductive material, such as the spar caps of the rotor blade. The conductive layer, as an example, may be mesh that includes tinned braided cables on the leading and trailing edges thereof to direct the lightning current attached at these edges into the mesh or straight to the tip conductor. In certain embodiments, the conductive layer may be electrically connected to the spar caps via a hand layup connection to maximize the contact surface area of the mesh. In addition, the method includes electrically connecting the tip-side edge of the conductive layer of material with the blade tip, e.g. by electrically connecting the mesh and braided cables to the conductive tip through a tinned plate. In such embodiments, the tinned plate between the two conductive materials helps reduce the galvanic corrosion effects at the connection. Also, the rivets used in the connection also help to reduce the effects of galvanic corrosion. Moreover, in an embodiment, the method may include covering the conductive layer with an outer covering, such as a blade sleeve.

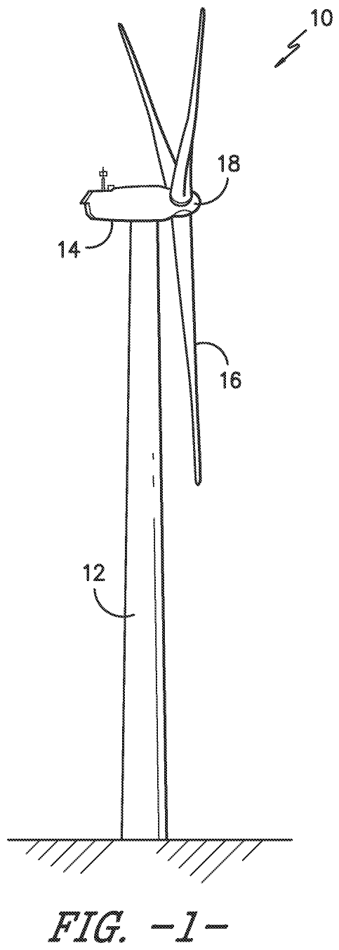

Referring now to the drawings, FIG. 1 illustrates a wind turbine 10 of conventional construction. The wind turbine 10 includes a tower 12 with a nacelle 14 mounted thereon. A plurality of blades 16 are mounted to a rotor hub 18, which is in turn connected to a main flange that turns a main rotor shaft. The wind turbine power generation and control components are housed within the nacelle 14. The view of FIG. 1 is provided for illustrative purposes only to place the present invention in an exemplary field of use. It should be appreciated that the invention is not limited to any particular type of wind turbine configuration.

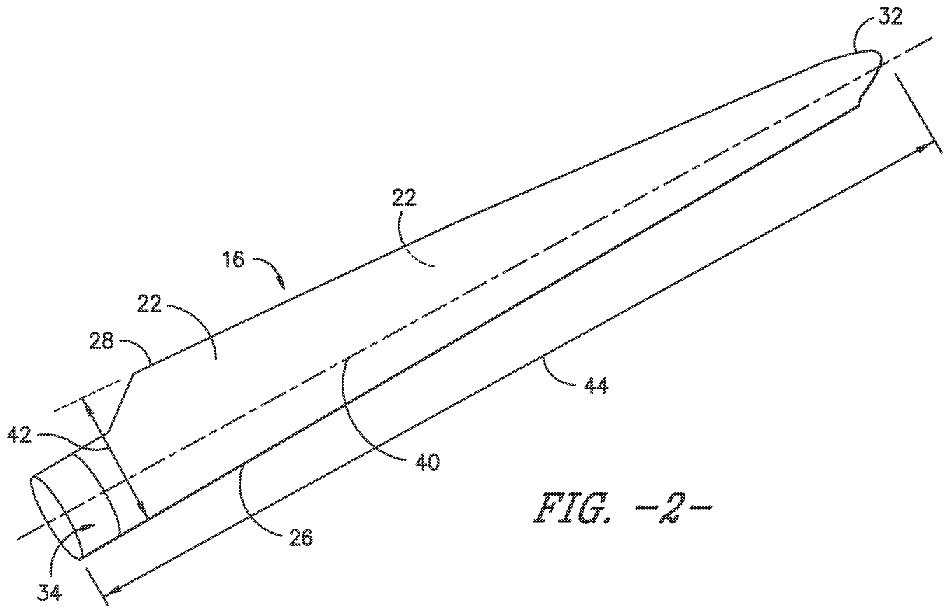

Referring now to FIG. 2, a rotor blade 16 of the wind turbine 10 according to the present disclosure is illustrated. As shown, the rotor blade 16 has a pressure side 22 and a suction side 24 extending between a leading edge 26 and a trailing edge 28 that extend from a blade tip 32 to a blade root 34. The rotor blade 16 further defines a pitch axis 40 relative to the rotor hub 18 (FIG. 1) that typically extends perpendicularly to the rotor hub 18 and blade root 34 through the center of the blade root 34. A pitch angle or blade pitch of the rotor blade 16, i.e., an angle that determines a perspective of the rotor blade 16 with respect to the air flow past the wind turbine 10, may be defined by rotation of the rotor blade 16 about the pitch axis 40. In addition, the rotor blade 16 further defines a chord 42 and a span 44. More specifically, as shown in FIG. 2, the chord 42 may vary throughout the span 44 of the rotor blade 16. Thus, a local chord may be defined for the rotor blade 16 at any point on the blade 16 along the span 44.

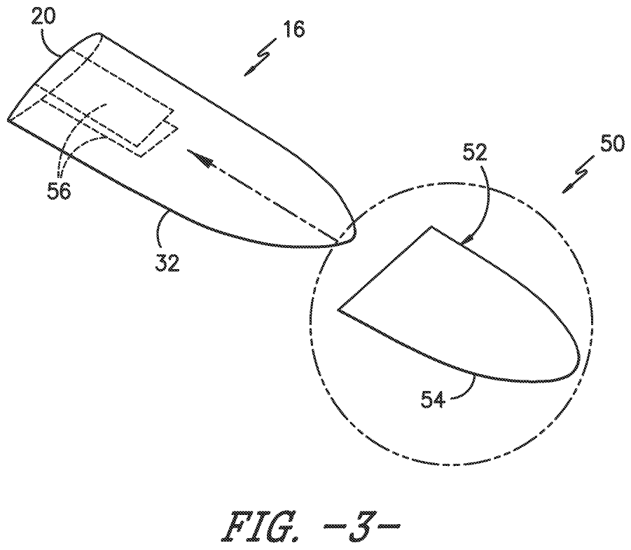

Referring now to FIG. 3, a perspective view of one embodiment of the blade tip 32 of the rotor blade 16 of FIG. 2 is illustrated. In particular, the blade tip 32 includes at least a part of one embodiment of a lightning protection system 50 according to the present disclosure. The lightning protection system 50 is easily adapted to rotor blades that have already been installed or may be installed onto rotor blades before installed. As shown, the lightning protection system 50 includes a conductive element 52 disposed at the blade tip 32, which may be substantially flat sheet, mesh or foil of electrically conductive or semi-conductive material. Further, as shown, an outer periphery 54 of the conductive element 52 may have substantially the same aerodynamic form as the blade tip 32 of the rotor blade 16. Furthermore, in an embodiment, the rotor blade 16 may be constructed from a glass-reinforced fiber or carbon-reinforced material. Thus, the conductive element 52 forms an electric field control region causing a lightning discharge to attach to the blade tip 32 of the rotor blade 16 during a lightning strike. Further, the conductive element 52 is in electrical communication with a conductive path such as, without limitation, a down conductor 66 depicted in FIG. 4. As such, the down conductor 66 and the conductive element 52 are configured to function to control the electric field caused by a lightning strike in the blade tip 32 of the rotor blade 16.

Moreover, the conductive element 52 may be configured to form a type of Faraday cage around the blade tip 32 of the rotor blade 16. In certain embodiments, this type of Faraday cage can be extended along the complete rotor blade surface if required for a particular application.

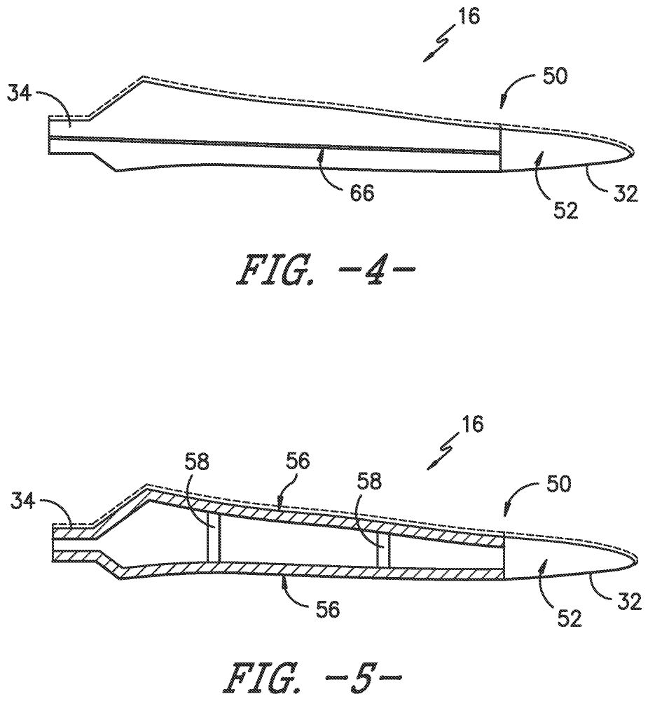

Referring now to FIG. 5, the conductive element 52 may also be connected to an external or integrated structural features 56, 58 of the rotor blade 16. For example, as shown in FIGS. 3 and 5, one or more conductive or semi-conductive spar caps 56 may be disposed on internal portion(s) of one side or both the suction and pressure sides 22, 24 and in close proximity to, but displaced from, one or both the leading and trailing edges 26, 28 of the rotor blade 16. Similarly, as shown, one or more conductive or semi-conductive shear webs 58 may be disposed between opposing spar caps 56. Due to the conductive characteristics of the spar caps 56 and shear web 58, combined with its large dimensions compared to discrete receptors, breakdown discharges across the rotor blade 16 (i.e. fiber or carbon-reinforced) are minimized. This is achieved by decreasing the surface impedance compared to the impedance of the composite material, such that a lightning leader will be guided to the nearest conductive attachment point before a high value current flashover occurs. The current density on the rotor blade 16 caused by a lightning strike will be reduced, leading to minimized thermal loading, due to the large dimensions of the conductive or semi-conductive material. Accordingly, transversal stress-relief conductive paths created the shear webs 58 can help to minimize the forces caused by the lightning current flowing along two parallel conductors.

As mentioned, in some instances, the lightning protection system 50 may become damaged for various reasons during operation of the wind turbine 10. Thus, the present disclosure is directed to improved methods for repairing or improving the lighting protection system 50. It should be understood that the lightning protection system 50 described herein is provided as an example only and is not meant to be limiting. Therefore, one of ordinary skill in the art would recognize that the repair method of the present disclosure may also be applied to any lightning protection system now known or later developed in the art.

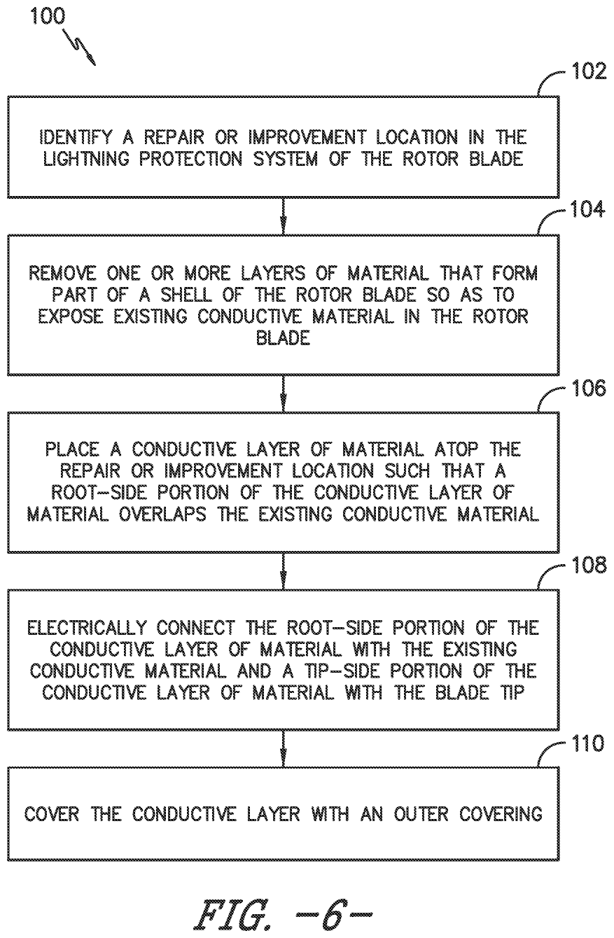

Referring now to FIG. 6, a flow diagram of one embodiment of a method 100 method for repairing or improving a lightning protection system of a rotor blade of a wind turbine, such as the lighting protection system 50, is illustrated in accordance with aspects of the present subject matter. In general, the method 100 will be described herein as being implemented using a wind turbine, such as the wind turbine 10 described herein. However, it should be appreciated that the disclosed method 100 may be implemented using any other wind turbine having any lightning protection system. In addition, although FIG. 6 depicts steps performed in a particular order for purposes of illustration and discussion, the methods described herein are not limited to any particular order or arrangement. One skilled in the art, using the disclosures provided herein, will appreciate that various steps of the methods can be omitted, rearranged, combined and/or adapted in various ways.

As shown at (102), the method 100 includes identifying a repair or improvement location 150 in the lightning protection system 50 of the rotor blade 16. As generally understood, the repair or improvement location can be identified, e.g. by field failures, additional testing, research, etc. such that location warrants an enhancement and/or repair. Thus, in certain embodiments, the repair or improvement location 150 may have at least one defect that needs repair and/or replacement. Thus, as shown at (104), the method 100 includes removing one or more layers of material at the repair or improvement location that form part of a shell of the rotor blade 16 so as to expose existing conductive material 154 in the rotor blade 16. For example, as shown in FIG. 7, a perspective view of one embodiment of the blade tip 32 of the rotor blade 16 is illustrated with the damaged layers of material removed. In particular, as shown, the existing mesh (such as conductive element 52) has also been removed. In addition, as shown, the method 100 may also include removing all existing resin at the repair or improvement location, thereby exposing the existing conductive material 154 (e.g. existing carbon layers). In such embodiments, the existing conductive material 154, as an example, may be part of the spar cap(s) 56 and/or the shear web 58 of the rotor blade 16.

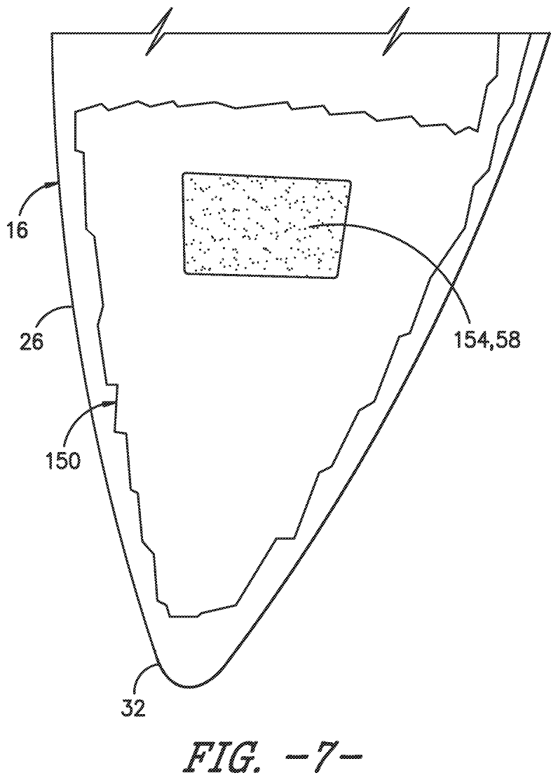

Accordingly, referring back to FIG. 6, as shown at (106), the method 100 includes placing a conductive layer 156 of material atop the repair or improvement location 150 such that a root-side edge 158 of the conductive layer 156 of material overlaps the existing conductive material 154. For example, as shown in FIG. 8, another perspective view of one embodiment of the blade tip 32 of the rotor blade 16 is illustrated with the conductive layer 156 of material placed atop the repair or improvement location. In certain embodiments, the conductive layer 156 of material may be a solid sheet, a wire mesh, a webbing, a netting, a woven sheet, or similar.

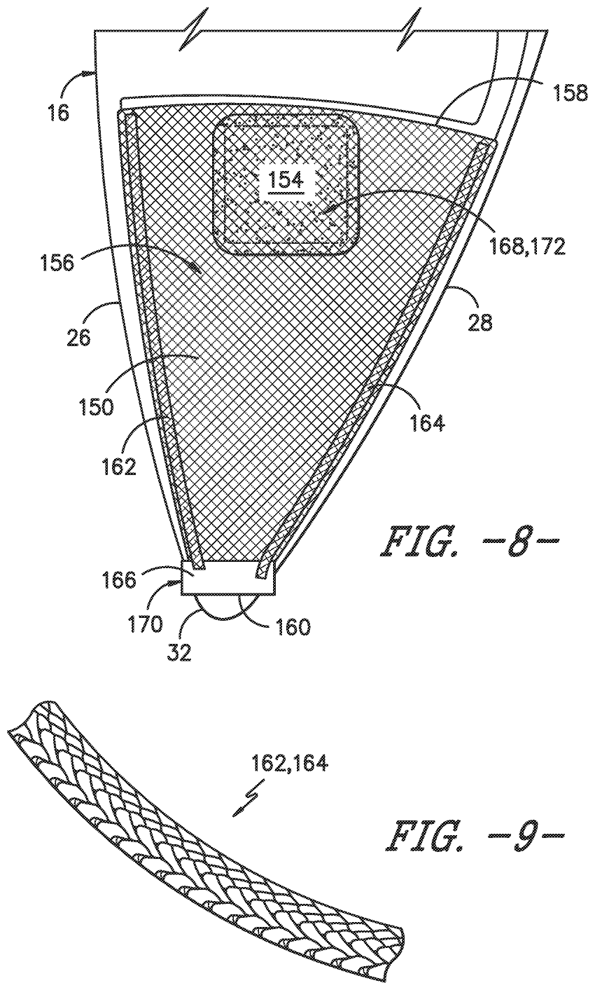

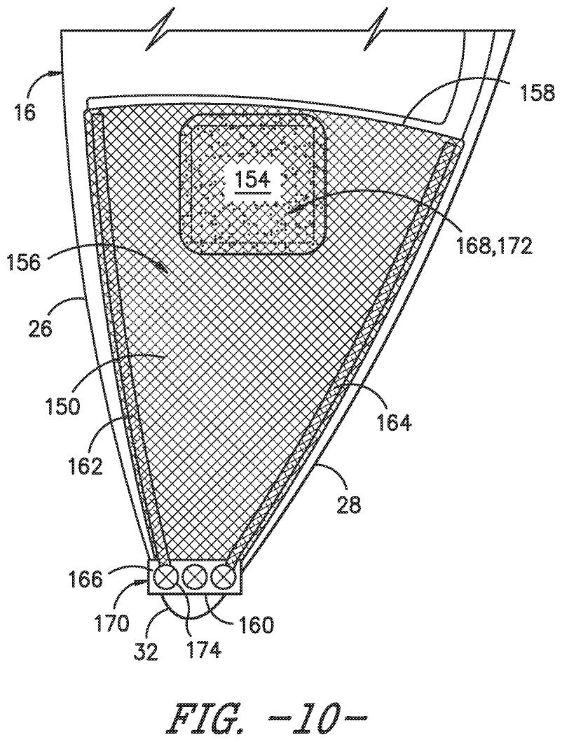

Further, as shown in FIGS. 8 and 10, in an embodiment, the conductive layer 156 of material may also include a first strip 162 of continuous material and a second strip 164 of continuous material extending from the root-side edge 158 of the conductive layer 156 of material to a tip-side edge 160 of the conductive layer 156 of material. In such embodiments, as shown, the first and second strips 162, 164 of material have a thickness that is greater than a thickness of remaining portions of the conductive layer of material. In particular embodiments, as an example, as shown in FIGS. 8 and 9, the first and second strips 162, 164 of continuous material may include first and second tinned braided cables, respectively. In addition, as shown in FIGS. 8 and 10, the first strip 162 of continuous material may be positioned adjacent to the leading edge 26 of the rotor blade 16 and the second strip 164 of continuous material may be positioned adjacent to the trailing edge 28 of the rotor blade 16. In such embodiments, the first and second strips 162, 164 of continuous material may be any suitable conductive material, e.g. such as copper, and desirably run the full length of the conductive layer 156 of material. Furthermore, the first and second strips 162, 164 of continuous material may have different thicknesses as needed to assist with the lightning current, i.e. due to the attractive sharp edges of the leading and trailing edges 26, 28. In yet another embodiment, the first and second strips 162, 164 of continuous material may be secured to the conductive layer 156 of material using any suitable means, e.g. such as soldering, mechanical fasteners, adhesives, or a combination of both.

Still referring to FIGS. 8 and 10, the conductive layer 156 of material may further include a conductive plate 166 secured at the tip-side edge 160 thereof. In such embodiment, the conductive plate 166 may be a tinned plate, copper, titanium, Inconel®, or any other suitable conductive material. Moreover, in certain embodiments, the conductive plate 166 may have any suitable size and/or thickness depending on the blade application. Accordingly, in an embodiment, the conductive plate 166 protects the down conductor from galvanic corrosion with the conductive layer 156 of material. Moreover, in particular embodiments, the conductive plate 166 may be soldered to the conductive layer 156 of material and/or the first and second strips 162, 164 of continuous material. In such embodiments, the conductive plate 166 increases the surface area of the electrical connection (which, in prior art systems, was limited to the surface area of rivets alone).

Referring back to FIG. 6, as shown at (108), the method 100 includes electrically connecting the root-side edge 158 of the conductive layer 156 of material with the existing conductive material 154 (e.g. from one of the spar caps 58) and also electrically connecting a tip-side edge 160 of the conductive layer 156 of material with the blade tip 32. For example, as shown in FIGS. 8 and 10, the root-side edge 158 of the conductive layer 156 of material may be electrically connected to the existing conductive material 154 via a first electrical connection 168, whereas the tip-side edge 160 of the conductive layer 156 of material may be electrically connected to the blade tip 32 via a second electrical connection 170.

In one embodiment, as an example, the root-side edge 158 of the conductive layer 156 of material may be electrically connected with the existing conductive material 154 via a conductive adhesive material 172 (as shown in FIGS. 8 and 10), such as any suitable conductive resin material. In an embodiment, for example, the conductive adhesive material 172 may include carbon biax. In an embodiment, as an example, the hand layup portion of the conductive adhesive material 172 may be constructed from carbon or some other conductive fiber to ensure current transfer between the conductive layer 156 and the existing conductive material 154 with maximized contact surface area. Thus, the larger the surface contact area of the attachment, the lower the current through a small area, thereby reducing the risk of damage to the rotor blade 16.

In addition, as shown in FIG. 10, the tip-side edge 160 of the conductive layer 156 of material may be electrically connected with the blade tip 32 of the rotor blade 16 through the conductive plate 166. In particular embodiments, for example, the method 100 may include securing the tip-side edge 160 of the conductive layer 156 of material to the blade tip 32 through the conductive plate 166 via at least one of one or more fasteners or soldering. More specifically, as shown in FIGS. 10 and 11, the conductive layer 156 of material is electrically connected to the blade tip 32 through the conductive plate 166 using at least one rivet 174.

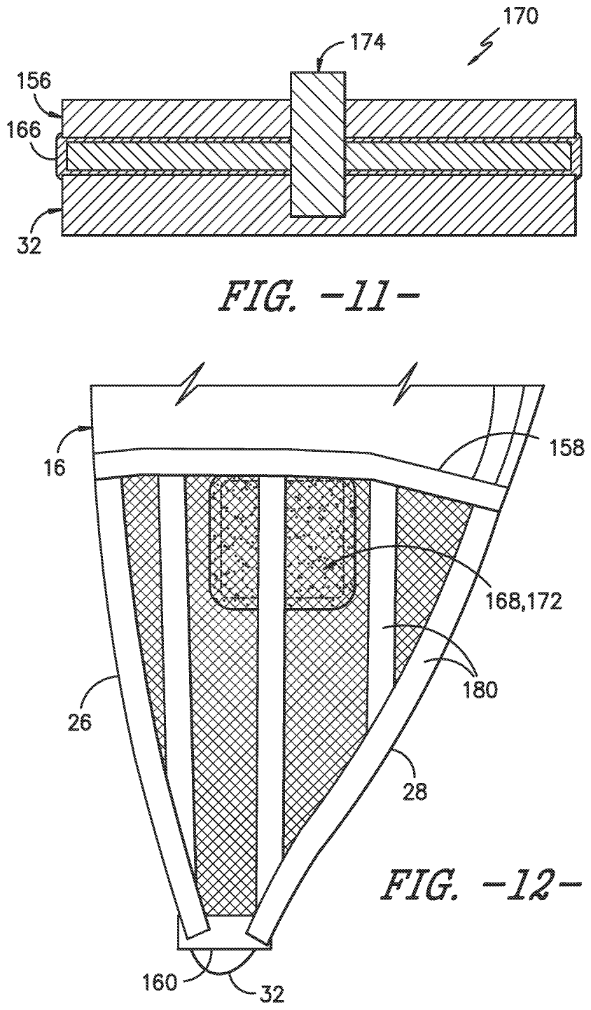

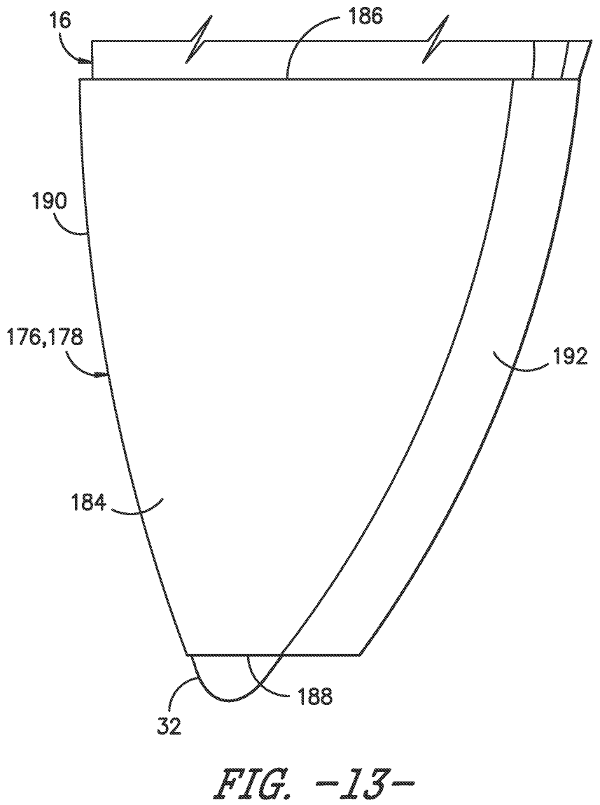

As shown at (110), the method 100 includes covering the conductive layer 156 with an outer covering 176. For example, as shown in FIGS. 12 and 13, covering the conductive layer with the outer covering 176 may include providing an adhesive 180 at the repair or improvement location 150 and sliding a blade sleeve 178 onto the rotor blade 16 so as to cover the conductive layer 156 of material. Thus, the adhesive 180 is configured to secure the blade sleeve 178 in place. In one embodiment, as an example, the adhesive 180 may be methyl methacrylate (MMA) though any other suitable adhesive may also be used to secure the sleeve 178 in place.

In such embodiments, as shown particularly in FIGS. 13 and 14, the blade sleeve 178 may be a unitary component having a pressure side 182, a suction side 184, a first open span-wise end 186, a second open span-wise end 188 opposite the first open span-wise end 186, a closed leading edge 190, and an open trailing edge 192. In further embodiments, as shown, the rotor blade 16 may be configured to extend through the first and second open span-wise ends 186, 188 of the blade sleeve 178. Thus, as shown, the blade tip 32 of the rotor blade 16 may extend at least partially through the second open span-wise end 188 of the blade sleeve 178. As such, the blade tip 32 may include an additional lightning receptor 194 that can be exposed via the second open span-wise end 188. It should be understood that the embodiment of the blade sleeve 178 having two open span wise ends 186, 188 may be located at any suitable span-wise location of the rotor blade 16, including near the blade tip 32 as well as a more inboard location, e.g. toward mid-span.

As such, in an embodiment, sliding the blade sleeve 178 onto the rotor blade 16 so as to cover the conductive layer 156 of material may include separating the pressure and suction sides 182, 184 at the open trailing edge 192, sliding the open trailing edge 192 of the blade sleeve 178 over the rotor blade 16, and once the conductive layer 156 of material is covered, securing the pressure and suction sides 182, 184 back together.

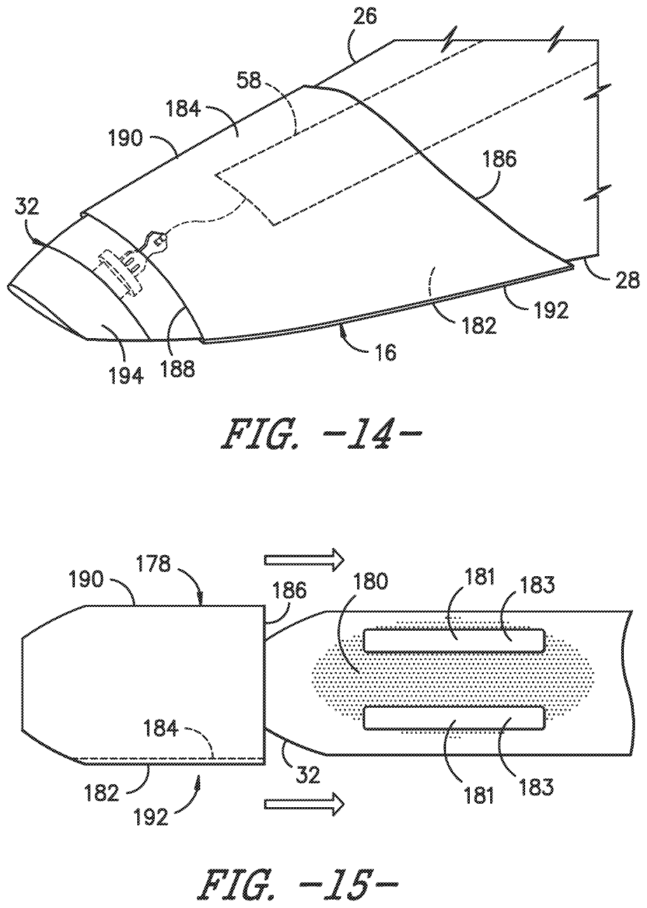

In particular embodiments, as shown in FIGS. 15-19, the blade sleeve 178 is slidable onto the blade tip 32 of the rotor blade 16. More specifically, as shown, the trailing edge 192 of the blade sleeve 178 may be separated in that the suction side 184 and the pressure side 182 are not bonded or sealed together along at least part of the length of the trailing edge 192, which allows the pressure and suction sides 182, 184 of the blade sleeve 178 to be pulled apart to an extent necessary to slide the blade sleeve 178 onto the blade tip 32. In certain embodiments as depicted in the figures, the trailing edge 192 is separated along essentially the entire length of the trailing edge, although this is not a requirement for all embodiments. In such embodiments, the separated trailing edge 192 can also be useful for draining water that accumulates in the blade sleeve 178, potentially escaping out of enclosed drain holes of the rotor blade 16.

Although FIG. 15 depicts (by arrows) the blade sleeve 178 being slid linearly in a span-wise direction onto the rotor blade 16, it should be appreciated that this sliding motion may include a chord-wise direction component that is aided by the separated nature of the trailing edge 192. In still another embodiment, the trailing edge 192 may not be separated.

It should also be understood that the blade sleeve 178 may be attached to the rotor blade 16 using any other suitable attachment methods in addition the adhesive 180 illustrated in FIGS. 12 and 13. For example, as shown in FIGS. 15-19, strips of double-sided adhesive tape 181 may be adhered in any desired pattern or configuration onto the blade tip 32 on either surface, including the pressure and/or suction sides of the rotor blade 16. It should be appreciated that a single, larger strip of tape 181 could also be utilized in place of multiple strips. The pattern of the tape strips 181 may be span-wise oriented and spaced-apart, as depicted in FIG. 15. It should be appreciated that the tape strips 181 may be applied to either or both of the blade surfaces 22, 24. The tape strips 181 may also have a release liner 183 attached to exposed sides of the tape 181 to protect an underlying adhesive layer 185.

In the embodiment of FIG. 15, the tape strips 181 are initially adhered to the blade surface, wherein the blade sleeve 178 is subsequently held or otherwise maintained in the desired position on the rotor blade 16 (e.g., by being pressed against the tape strips 181) for subsequent removal of the release liner 183 from between the underside of the blade sleeve 178 and the tape 181. It should be appreciated that there may be some degree of inherent “play” or movement of the blade sleeve 178 at the desired position on the blade 16 as the release liners 183 are removed.

In an alternate embodiment, the tape strips 181 may be applied to an inner surface of the blade sleeve 178 in the same pattern discussed above, which is then pressed against the blade surface(s) for subsequent removal of the release liner 183 from the opposite side of the tape 181 (as explained more fully below).

As mentioned, and further illustrated in FIG. 15, it may also be desired to coat the surface of the rotor blade 16 where the blade sleeve 178 will be placed with a liquid or paste adhesive (e.g., and epoxy) 180, for example to compensate for any surface irregularities or mismatch between the blade surface and the blade sleeve 178 due, for example, to machining tolerances, before positioning the tape strips 181 on the blade surface. The tape strips 181 and blade sleeve 178 can then be attached before the adhesive 180 cures, which provides a degree of positioning adjust of the blade sleeve 178 due to the fact that the adhesive 180 is still in liquid or paste form. Alternatively, the adhesive 180 (with tape strips attached thereto) may be allowed to cure before placement of the blade sleeve 178. In either case, this particular embodiment also gives the advantage of a strong bond provided by the adhesive 180 in combination with the shear stress reduction provided by the tape strips 181. It should be further understood that the adhesive 180 may be used without the tape strips, e.g. as shown in FIGS. 12 and 13.

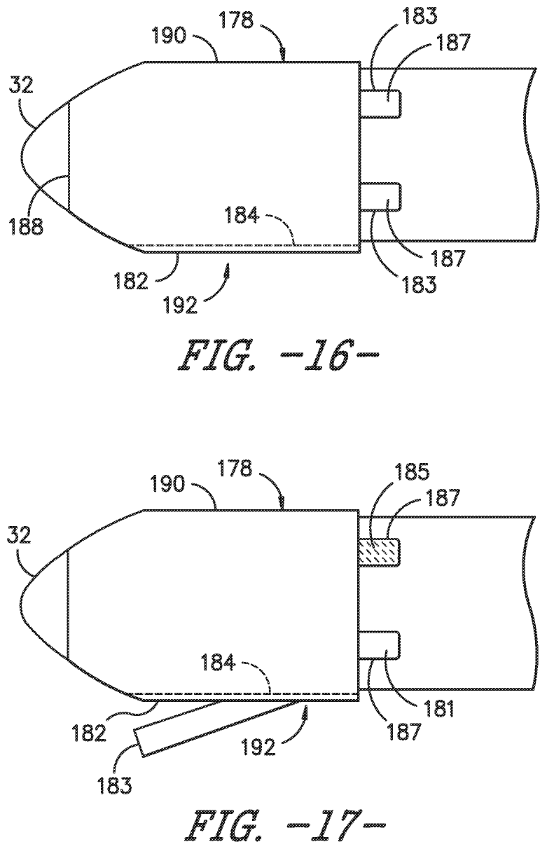

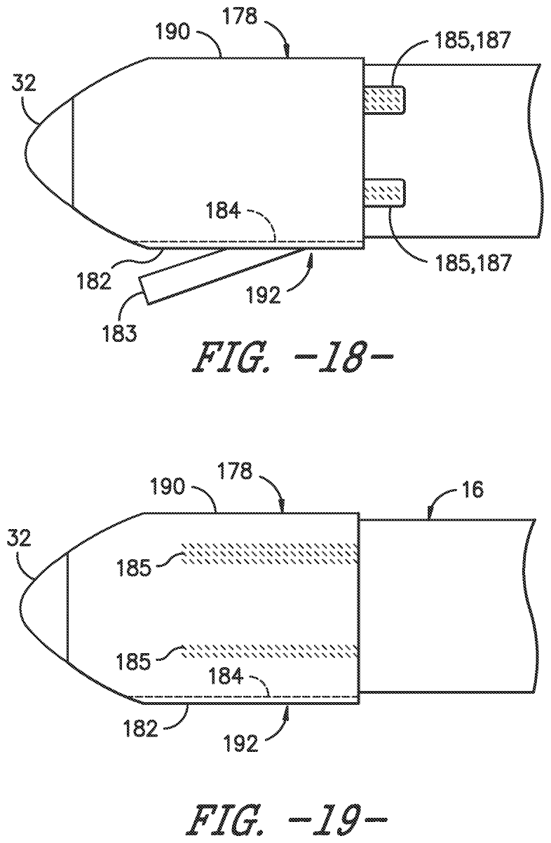

Referring particularly to FIGS. 16-18, each of the tape strips 181 may have a length so as to define an extension tail 187 that extends span-wise beyond the span-wise end 186 of the blade sleeve 178. The length of the extension tails 187 may vary. For example, the strips 181 furthest from the trailing edge 192 may have a longer extension tail 187 to facilitate pulling the extension tail through the trailing edge 192, as compared to the tape strip 181 closest to the trailing edge 192. Alternatively, the extension tail 187 may encompass any other material or component that is attached to the tape strip, such as a wire, string, ribbon, and so forth. With the illustrated embodiment, because the extension tails 187 are comprised of the release liner 183 and underlying adhesive, as depicted in FIG. 16, after removal of the release liner 183, the remaining adhesive layer of the tape strips adhesive 185 remains, as depicted in FIG. 17, and may need to be trimmed.

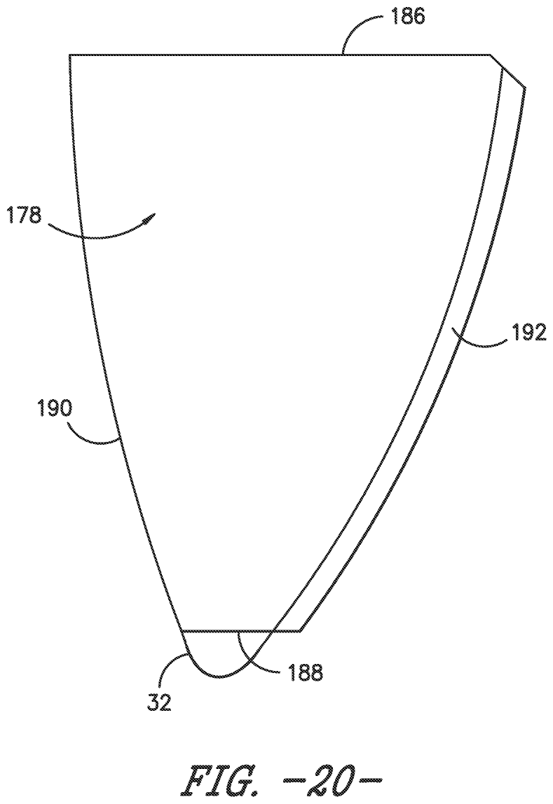

Referring to FIGS. 16-19, with the blade sleeve 178 held at the desired position on the blade tip 32, starting from the tape strip 181 furthest from the separated trailing edge 192, the extension tails 187 and the release liners 183 of the respective tape strips 181 are pulled through the separated trailing edge 192 and away from the blade sleeve 178 at an angle such that that entire release liner 183 is removed along the length of the tape strip 181 while maintaining position of the blade sleeve 178 against the blade surface to attach the exposed adhesive 185 under the release liner 183 to either the surface of the rotor blade 16 or the inner surface of the blade sleeve 178 (depending on initial placement of the tape strips 181 on the blade surface or on the interior surface of the blade sleeve 178). After all of the release liners 183 have been removed in sequential order from furthest to closest to the separated trailing edge 192, the remaining adhesive layers 185 can be trimmed to provide the finished blade depicted in FIG. 19.

Referring still to FIGS. 15-19, in embodiments having a separated trailing edge 192, the pressure and suction sides 182, 184 of the separated trailing edge 192 may extend past the trailing edge 28 of the rotor blade 16 to provide a chord-wise extension aspect to the blade sleeve 178. These edges can then be bonded together after attaching the blade sleeve 178 to the rotor blade 16 in the manner discussed above. The sides 182, 184 may extend an equal chord-wise distance past the blade trailing edge 28, or the sides 182, 184 may be offset in that one of the sides 182, 184 extends past the other. The dashed line indicating the suction side 184 is meant to depict both of these configurations. In an alternate embodiment, the suction and pressure side surface edges 182, 184 extend equally beyond the trailing edge 28 of the rotor blade 16.

It should be appreciated that the methods described herein may be implemented with a number of different commercially available double-sided adhesive tapes. For example, the tape strips 181 may be a foam-based strip member with adhesive on opposite interface sides thereof, such as a Very High Bond (VHB™) or SAFT (Solar Acrylic Foam Tape) foam-based strip material.

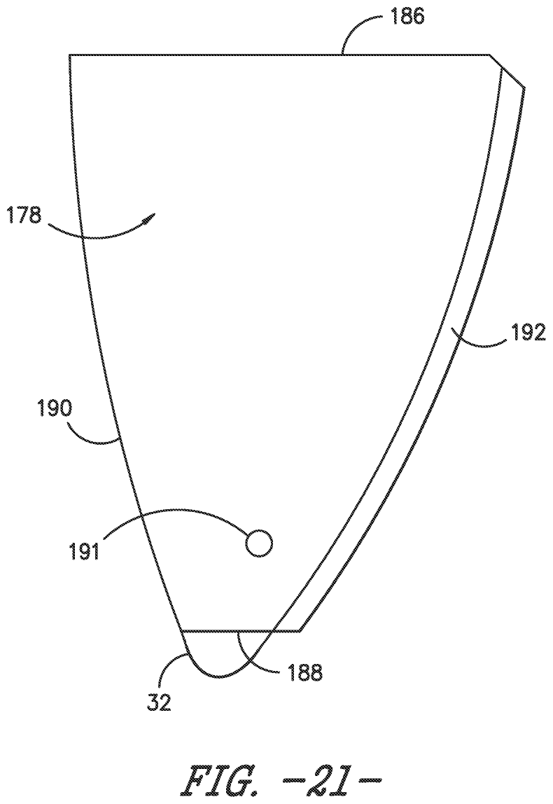

Referring now to FIGS. 20-21, once the blade sleeve 178 is installed, in an embodiment, the method 100 may include trimming the blade sleeve 178 at the trailing edge thereof. In such embodiments, as shown, trimming the blade sleeve 178 at the trailing edge thereof may include chamfering the root-side edge of the blade sleeve 178 (e.g. at the first, open span-wise end 186) and the tip-side edge of the blade sleeve 178 (e.g. at the second, open span-wise end 188).

Moreover, as shown in FIGS. 20-21, the method 100 may also include providing one or more finishing components to the blade sleeve 178 once installed on the rotor blade 16. For example, in an embodiment, the finishing component(s) may include forming at least one drain hole 191 in the blade sleeve 178, painting or providing a coating onto the blade sleeve, placing a filler material within the blade sleeve 178, or contouring the blade sleeve 178 to correspond to an exterior surface of the rotor blade 16.

In further embodiments, the blade sleeve 178 described herein may be constructed of a thermoplastic material. The thermoplastic materials as described herein may generally encompass a plastic material or polymer that is reversible in nature. For example, thermoplastic materials typically become pliable or moldable when heated to a certain temperature and returns to a more rigid state upon cooling. Further, thermoplastic materials may include amorphous thermoplastic materials and/or semi-crystalline thermoplastic materials. For example, some amorphous thermoplastic materials may generally include, but are not limited to, styrenes, vinyls, cellulosics, polyesters, acrylics, polysulphones, and/or imides. More specifically, exemplary amorphous thermoplastic materials may include polystyrene, acrylonitrile butadiene styrene (ABS), polymethyl methacrylate (PMMA), glycolised polyethylene terephthalate (PET-G), polycarbonate, polyvinyl acetate, amorphous polyamide, polyvinyl chlorides (PVC), polyvinylidene chloride, polyurethane, or any other suitable amorphous thermoplastic material. In addition, exemplary semi-crystalline thermoplastic materials may generally include, but are not limited to polyolefins, polyamides, fluoropolymer, ethyl-methyl acrylate, polyesters, polycarbonates, and/or acetals. More specifically, exemplary semi-crystalline thermoplastic materials may include polybutylene terephthalate (PBT), polyethylene terephthalate (PET), polypropylene, polyphenyl sulfide, polyethylene, polyamide (nylon), polyetherketone, or any other suitable semi-crystalline thermoplastic material.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method for repairing or improving a lightning protection system of a rotor blade of a wind turbine, the rotor blade having a blade root and a blade tip, the method comprising:
identifying a repair or improvement location in the lightning protection system of the rotor blade;
removing one or more layers of material at the repair or improvement location that form part of a shell of the rotor blade so as to expose existing conductive material in the rotor blade;
placing a conductive layer of material atop the repair or improvement location such that a root-side edge of the conductive layer of material overlaps the existing conductive material;
electrically connecting the root-side edge of the conductive layer of material with the existing conductive material and a tip-side edge of the conductive layer of material with the blade tip; and
covering the conductive layer with an outer covering.

2. The method of claim 1, wherein the existing conductive material is part of at least one of a spar cap or a shear web of the rotor blade.

3. The method of claim 1, wherein the conductive layer of material further comprises a first strip of continuous material and a second strip of continuous material extending from the root-side edge of the conductive layer of material to the tip-side edge of the conductive layer of material, the first and second strips of material having a thickness that is greater than a thickness of remaining portions of the conductive layer of material.

4. The method of claim 3, wherein the first and second strips of continuous material comprise first and second tinned braided cables, respectively.

5. The method of claim 3, wherein the first strip of continuous material is positioned adjacent to a leading edge of the rotor blade and the second strip of continuous material is positioned adjacent to a trailing edge of the rotor blade.

6. The method of claim 1, wherein the conductive layer of material further comprises a conductive plate secured at the tip-side edge thereof.

7. The method of claim 6, wherein electrically connecting the root-side edge of the conductive layer of material with the existing conductive material and the tip-side edge of the conductive layer of material with the blade tip of the rotor blade further comprises:
electrically connecting the root-side edge of the conductive layer of material to the existing conductive material via a conductive adhesive material; and
electrically connecting the tip-side edge of the conductive layer of material to the blade tip through the conductive plate.

8. The method of claim 7, further comprising securing the tip-side edge of the conductive layer of material to the blade tip through the conductive plate via at least one of one or more fasteners or soldering.

9. The method of claim 6, wherein the conductive plate is soldered to the conductive layer of material and the first and second strips of continuous material.

10. The method of any of the preceding claims, wherein the conductive layer of material comprises at least one of a solid sheet, a wire mesh, a webbing, a netting, or a woven sheet.

11. The method of claim 1, wherein covering the conductive layer with the outer covering further comprises:
sliding a blade sleeve onto the rotor blade so as to cover the conductive layer of material; and
securing the blade sleeve to the rotor blade.

12. The method of claim 11, wherein the blade sleeve is a unitary component comprising a pressure side, a suction side, a first open span-wise end, a second open span-wise end opposite the first open span-wise end, a closed leading edge, and an open trailing edge, the rotor blade configured to extend through the first and second open span-wise ends, wherein sliding the blade sleeve onto the rotor blade so as to cover the conductive layer of material further comprises separating the pressure and suction sides at the open trailing edge, sliding the open trailing edge of the blade sleeve over the rotor blade, and once the conductive layer of material is covered, securing the pressure and suction sides back together.

13. The method of claim 11, wherein the blade sleeve is constructed of a thermoplastic material.

14. The method of claim 12, further comprising trimming the blade sleeve at the trailing edge thereof.

15. The method of claim 14, wherein trimming the blade sleeve at the trailing edge thereof further comprises chamfering a root-side edge of the blade sleeve and a tip-side edge of the blade sleeve.

16. The method of claim 11, further comprising providing one or more finishing components to the blade sleeve once installed on the rotor blade, the one or more finishing components comprising at least one of forming at least one drain hole in the blade sleeve, painting or providing a coating onto the blade sleeve, placing a filler material within the blade sleeve, or contouring the blade sleeve to correspond to an exterior surface of the rotor blade.

17. A rotor blade assembly, comprising:
a rotor blade extending between a blade root and a blade tip, the rotor blade having a pressure side, a suction side, a leading edge, and a trailing edge;
at least one conductive structural component arranged within an inner cavity of the rotor blade;
a conductive layer of material adjacent to at least one of the pressure side or the suction side of the rotor blade at the blade tip, the conductive layer of material comprising a root-side edge and a tip-side edge, the root-side edge overlapping a portion of the at least one conductive structural component at an interface, the conductive layer of material further comprising opposing edges having a thickness that is greater than remaining portions of the conductive layer of material and a conductive plate at the tip-side edge;
a first electrical connection between the root-side edge of the conductive layer of material and the at least one structural component at the interface, the first electrical connection comprising a conductive adhesive material; and,
a second electrical connection between the tip-side edge of the conductive layer of material, the conductive plate, and a blade tip of the rotor blade.

18. The rotor blade assembly of claim 17, wherein the thickness of the opposing edges is created by first and second tinned braided cables, respectively, the first tinned braided cable being positioned adjacent to the leading edge of the rotor blade and the second tinned braided cable being positioned adjacent to the trailing edge of the rotor blade.

19. The rotor blade assembly of claim 17, wherein the second electrical connection is formed via at least one of soldering or one or more fasteners.

20. The rotor blade assembly of claim 17, further comprising a blade sleeve secured over the conductive layer of material, the blade sleeve comprising a pressure side, a suction side, a first open span-wise end, a second open span-wise end opposite the first open span-wise end, a closed leading edge, and an open trailing edge, the rotor blade configured to extend through the first and second open span-wise ends.
